(19) United States
(12) Patent Application Publication
(10) Pub. No.: US 2026/0006557 A1
(43) Pub. Date: Jan. 1, 2026

(54) SMART RECOGNITION AND CONSUMER-CENTRIC ACTIVITY RECOGNITION BASED SYSTEM FOR BATTERY MANAGEMENT IN MOBILE DEVICE

(71) Applicants: Sultan Ahmed ALMALKI, Najran (SA); Tami Abdulrahman ALGHAMDI, Al-Baha (SA); Abhishek SHARMA, Gwalior (IN); Sunil SHARMA, Majmaah (SA)

(72) Inventors: Sultan Ahmed ALMALKI, Najran (SA); Tami Abdulrahman ALGHAMDI, Al-Baha (SA); Abhishek SHARMA, Gwalior (IN); Sunil SHARMA, Majmaah (SA)

(21) Appl. No.: 19/320,576

(22) Filed: Sep. 5, 2025

(51) Int. Cl. H04W 52/02; G06F 21/57; H04W 4/14; H04W 4/90; H04W 64/00

(52) U.S. Cl. CPC H04W 52/0254; G06F 21/575; H04W 4/14; H04W 4/90; H04W 64/006; G06F 2221/034

(57) ABSTRACT

The present invention relates to an intelligent, context-aware battery management system embedded within a mobile device that dynamically allocates power resources based on real-time user behavior, system state, and environmental context. It incorporates a smart recognition engine that analyzes sensor-derived telemetry data to compute behavioral deviation scores, enabling the system to anticipate abnormal or emergency-prone conditions. A continuous activity classification module contextualizes user motion and geolocation to inform power policy decisions. Upon detecting significant behavioral anomalies or critically low battery conditions, an emergency mode subsystem is triggered, restricting device operations to essential functionalities while preserving energy for critical communication and navigation tasks. The system also establishes a secure, lightweight emergency communication tunnel for relaying essential metadata, including GPS and behavioral indicators, to predefined response servers.

### FIELD OF THE INVENTION

The present invention relates to battery management systems and more particularly to a system for managing battery power in mobile devices by utilizing smart recognition and consumer-centric activity recognition to ensure optimal battery availability for emergency usage. Further, it pertains to a context-aware, machine-learning-assisted battery management device integrated within a mobile device system-on-chip (SoC), which monitors user behavior and system status in real time to dynamically reallocate power resources and activate emergency preservation mechanisms under critical conditions.

### BACKGROUND OF THE INVENTION

Battery management systems (BMS) in mobile devices traditionally rely on static thresholds and heuristics, lacking the capacity to account for real-time context, user behavior variability, or emergent situations that may require adaptive prioritization of power resources. Moreover, conventional systems fail to integrate predictive intelligence for anticipatory action during emergencies or optimize component operation granularly based on application dependencies and system thermal states. There is a need for an intelligent, learning-based system that not only classifies user activity in real-time using multimodal sensor data but also correlates behavioral deviations and application usage to proactively adjust power management strategies. Furthermore, during critical low-battery states, such a system should seamlessly transition into a restricted operational mode optimized for emergency communication, security, and device survivability.

Mobile computing devices such as smartphones, tablets, and wearable electronics are becoming increasingly central to users' daily lives, serving as tools for communication, navigation, entertainment, and emergency response. As the demand for real-time connectivity, location-based services, and continuous sensing increases, the dependency on battery-powered operation intensifies. However, current battery management systems (BMS) embedded in mobile devices often rely on predefined heuristics, basic usage pattern estimations, and fixed operating thresholds to manage power allocation and trigger low-power modes. These legacy systems are reactive rather than predictive and lack the contextual awareness necessary to intelligently prioritize resource utilization during dynamically evolving user conditions or emergencies. Their limited adaptability often results in abrupt system shutdowns during critical moments or unnecessary throttling of performance during benign conditions.

Most contemporary solutions for mobile battery management are implemented at the operating system level, typically leveraging kernel-level power governors, wake-lock policies, and user-configurable battery-saving modes. The power governors manage CPU frequency scaling and control dynamic voltage and frequency scaling (DVFS) policies based on load averages, thermal conditions, and instantaneous battery state-of-charge. Although effective under predictable workloads, such policies do not consider real-time behavioral context, environmental conditions, or future energy availability predictions. For example, an Android device might trigger a “battery saver” mode at 15% battery threshold, uniformly limiting background data usage, dimming the screen, and restricting app activity regardless of the user's situational needs, time of day, or the importance of certain applications. This lack of nuance can lead to both inefficient energy usage and poor user experience.

In terms of emergency readiness, most mobile operating systems provide only rudimentary features. These may include static emergency contact lists accessible from the lock screen or limited integration with emergency alert systems. These features are typically decoupled from the battery management subsystem and operate without any intelligent assessment of the device's operational state, energy capacity, or the criticality of the user's activity context. A user traveling alone in an unfamiliar location late at night may have the same energy management policy enforced as during a routine workday, with no mechanism to elevate the device's awareness of potential risk or to allocate battery reserves for high-priority services like emergency calling or GPS tracking.

Existing predictive battery estimation models, such as linear regression models or simple machine learning techniques, attempt to estimate battery drain based on historical application usage or screen-on time. However, these models generally operate on coarse data and are not equipped to adapt to rapidly changing behavioral signals or to differentiate between high- and low-risk scenarios. They lack temporal sensitivity, failing to capture latent user intent or circadian behavioral deviations that may indicate emerging emergency states. Moreover, they do not incorporate anomaly detection techniques or contextual feedback from sensor-derived inputs, such as geolocation changes or motion data, that could provide critical insights into energy-aware behavioral forecasting.

Similarly, activity recognition systems—where implemented—are commonly found in health and fitness applications and are not tightly coupled with battery management or emergency alert subsystems. These systems often rely on single-sensor input, such as accelerometer data, and perform classification using hardcoded threshold-based logic or shallow classifiers. As a result, their accuracy is limited under noisy environmental conditions or non-standard movement patterns, and they are prone to false positives and negatives. There is minimal integration with the underlying power management infrastructure, rendering their output functionally irrelevant to broader system-level decision-making.

Another limitation of conventional battery preservation techniques is their treatment of applications as homogenous energy consumers without accounting for inter-application dependencies or the criticality of ongoing tasks. For instance, a background messaging application used for coordination during an emergency might be suspended during low-power mode, while a high-drain media app running in the foreground continues to consume resources. The absence of an application-level dependency graph or behavioral context leads to non-optimal decisions that can compromise both performance and user safety. Additionally, battery saver implementations often lack the granularity to throttle system components based on nuanced real-time data. CPU scaling policies operate at core-level granularity, failing to consider thread-level energy efficiency or responsiveness metrics that might better inform prioritization during constrained energy conditions.

Several research efforts have attempted to improve battery-aware operation through context modeling and machine learning. Some proposals introduce adaptive screen brightness using ambient light sensors or predictive pre-fetching of data based on usage patterns. However, these approaches are typically siloed and do not holistically integrate with all system layers, particularly in kernel space or in embedded firmware where finer-grained control is possible. Moreover, these systems rarely include robust fallback mechanisms for degraded environments where network connectivity is lost or battery levels are critically low. The failure to provide a secure, bandwidth-adaptive emergency communication channel under such constraints remains a major shortcoming in existing commercial and research-based systems.

Hardware-level power management solutions, such as Power Management Integrated Circuits (PMICs) and baseband processor energy modes, offer significant control over low-level power states but are often underutilized in consumer-grade mobile devices. Firmware in PMICs is typically responsible only for low-level control signals related to charging circuits, voltage regulation, and thermal protections. While these subsystems can enforce hard cutoffs to prevent damage, they are not configured to execute intelligent power-down sequences or contextual emergency boot procedures. Gesture recognition-based emergency activation, where implemented, is limited to simplistic input patterns without personalization or tolerance for variances like hand tremors or device debounce latency. Furthermore, the interpretation of such gestures is performed without any stateful awareness of the device's current energy profile or environmental context, thereby increasing the likelihood of both missed detections and false activations.

On the security front, current battery preservation systems rarely address the challenge of secure emergency signaling or post-event auditability. In scenarios where emergency communication is successfully triggered, there is no standard mechanism to validate the integrity of transmitted data, secure the payload, or maintain a verifiable log of system actions taken. Data sent over unsecured fallback channels may be susceptible to tampering or interception, while the absence of trusted execution environments for audit logging impairs the system's ability to support forensic analysis after the event. Additionally, most cloud-based emergency response frameworks do not support fine-grained, real-time coordination with mobile battery management systems, resulting in delayed or incomplete incident response.

Despite the inclusion of battery saver modes, power-efficient hardware components, and network-aware throttling mechanisms in modern mobile operating systems, the ability to orchestrate an intelligent, context-sensitive, energy-optimized emergency response remains underdeveloped. Current solutions lack integration across behavioral analytics, sensor fusion, application dependency modeling, and secure emergency signaling pathways. They fail to leverage advanced machine learning architectures such as recurrent neural networks or reinforcement learning to adapt to evolving usage patterns. Furthermore, the absence of an embedded decision framework that operates across the OS kernel, PMIC firmware, and application runtime layer prevents mobile systems from delivering reliable and personalized emergency power management. Therefore, there exists a critical gap in the design of mobile battery management devices-one that can be addressed through a unified system combining behavior modeling, dynamic optimization, embedded control, and secure communication to ensure robust functionality under the most energy-constrained and safety-critical scenarios.

### SUMMARY OF THE INVENTION

The present invention provides a battery management device embedded within the mobile device hardware-software stack, configured to recognize user behavior, predict emergency likelihoods, and dynamically control system resources to optimize battery utilization. This intelligent device comprises multiple tightly integrated components operating across the firmware, kernel, and user-space boundaries, including: (1) a smart recognition engine trained on time-series telemetry to model behavioral deviations; (2) a consumer-centric activity recognition module performing real-time user state classification using sensor fusion; (3) a dynamic power reallocation module interfaced with the power governor to apply prioritized energy conservation strategies; and (4) an emergency trigger subsystem capable of initiating an emergency mode that sandboxes applications, reduces screen and CPU activity, and ensures emergency services remain active. The primary object of the present invention is to provide an intelligent, context-aware battery management system embedded within a mobile device that can dynamically assess user behavior, system conditions, and environmental context to optimize energy utilization and ensure operational continuity during critical situations. This invention aims to overcome the limitations of existing battery management solutions by integrating a predictive, learning-based recognition engine with real-time sensor fusion and application prioritization logic, thereby enabling the device to make nuanced, data-driven decisions under both normal and emergency scenarios.

Another significant object of the invention is to introduce a smart recognition engine capable of analyzing time-series telemetry data, including application usage patterns, motion data, telephony logs, and user-device interaction events, in order to compute a behavioral deviation score that reflects the likelihood of abnormal or emergency-prone user behavior. By embedding this engine directly within a system-on-chip (SoC) processing core, the invention seeks to offer low-latency behavioral prediction and situational awareness without requiring cloud-based inference, thus preserving privacy and ensuring local autonomy even in connectivity-deprived environments.

An additional object of the invention is to enable continuous classification of user activity through a consumer-centric activity recognition module that fuses data from inertial, positional, and environmental sensors. The goal is to maintain an accurate model of user context—including movement states, circadian rhythm adherence, and geospatial anomalies—so that the system can preemptively adjust power policies in alignment with real-world user conditions, such as detecting when the user is in transit, outdoors at night, or deviating from habitual routines.

The invention also intends to provide a dynamic power reallocation mechanism that interfaces directly with the mobile device's operating system kernel and power governor. This mechanism is designed to compute an energy preservation envelope that takes into account thermal constraints, current battery charge, historical charging behavior, and application energy utility indices. By doing so, the system is able to reallocate power resources dynamically and suppress or downscale non-critical background tasks, while preserving resources for high-priority or emergency applications and subsystems.

Furthermore, the invention seeks to introduce an emergency trigger subsystem that operates both in software and embedded firmware layers, capable of initiating a low-power, high-survivability operational mode in response to either a recognized behavioral emergency pattern or a user-defined gesture input. This restricted operational state is designed to preserve essential communication capabilities such as telephony, GPS, and secure messaging, while shutting down non-essential peripherals and application processes, thereby extending device uptime under critical battery conditions.

Another object of the invention is to establish a secure and resilient emergency communication tunnel using cryptographic primitives anchored within a hardware security module. This allows the system to transmit critical metadata—including GPS coordinates, battery diagnostics, behavioral risk scores, and anonymized user activity logs—to a cloud-based emergency management server, even under low-bandwidth or degraded network conditions, ensuring reliable incident reporting and timely response coordination.

A further object of the invention is to support adaptive personalization of emergency detection and response thresholds using reinforcement learning techniques that simulate rare and adversarial user scenarios. By integrating a feedback loop between synthetic scenario simulations and real-world telemetry, the system continuously improves its prediction model, thereby enhancing its ability to detect and respond to low-frequency but high-impact events that traditional battery managers fail to capture.

The invention aims to ensure security, auditability, and post-event traceability through a tamper-resistant logging and diagnostic system embedded within a trusted execution environment. This component maintains a cryptographically verifiable log of system actions, energy decisions, and emergency transitions, enabling post hoc analysis and compliance with user-defined privacy and data retention policies. Through the collective realization of these objects, the invention delivers a comprehensive, technically advanced solution to mobile power management challenges in contextually volatile and resource-constrained environments.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a battery management system implemented within a mobile device in accordance with an embodiment of the present disclosure;

FIG. 2 displays flow chart of a method of operating a battery management battery management system in accordance with an embodiment of the present disclosure;

FIG. 3 displays a block diagram of a Smart Battery Management System Architecture implemented within a mobile device, in accordance with an embodiment of the present disclosure;

FIG. 4 displays a block diagram of an expanded system architecture of a mobile device-based emergency battery management framework, in accordance with an embodiment of the present disclosure;

FIG. 5 displays a block diagram of an expanded functional architecture of an Emergency Battery Management System with Real-Time AI Integration and Critical Data Retrieval, in accordance with an embodiment of the present disclosure;

FIG. 6 displays a mobile phone interface during emergency battery mode under the control of the proposed Smart Battery Management System, in accordance with an embodiment of the present disclosure; and

FIG. 7 displays a schematic layout of the internal hardware architecture of a mobile device configured with the proposed Smart Emergency Battery Management System, in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

In the current scenario, smartphones are extensively used for communication, financial transactions, entertainment, and a wide range of internet-based activities. As a result, battery life has become a critical limitation-regardless of the manufacturer's claims-especially when the device is urgently needed during emergencies. In such cases, it becomes extremely difficult to rely on a fully drained battery for immediate actions. Hence, it is essential to ensure that at least 5% to 10% of the battery capacity is preserved for emergency usage. The proposed system addresses this challenge through a dual-pronged approach comprising both hardware and software mechanisms designed to intelligently manage and conserve power during emergency situations.

The first approach involves the inclusion of a dedicated emergency battery hardware module within the mobile phone's power management system. This module comprises a battery regulator, a driver circuit, and an emergency battery unit equivalent to approximately 10% of the device's main battery capacity. This auxiliary circuit remains inactive during normal operation and is only activated based on real-time battery consumption metrics and application usage patterns. An R-2R ladder-based analog-to-digital converter is used to continuously monitor and calculate battery drain and consumption rates. When the main battery is fully depleted, a predefined bit state (bit value 1) is transmitted to trigger the emergency power management system. Upon activation, the system automatically converts the screen display to grayscale (black and white) mode, reducing power consumption by eliminating RGB rendering. Simultaneously, a visible counter begins running to inform the user of the estimated remaining usage time under emergency conditions.

The second approach integrates an artificial intelligence-enabled software system that intelligently reserves power for critical situations. This AI-powered component can function in two forms: (i) as a standalone emergency battery management application, and (ii) as an integrated system module within the device's operating system. The software monitors device activity and learns usage patterns to optimize battery conservation. It can be triggered via user-defined gestures or events, such as shaking the device, a double-click pattern, or a two-punch tap gesture, thereby enabling emergency mode even before total depletion of the main battery.

The proposed system ensures tight integration between the hardware and software modules, such that emergency mode can only be activated when the primary battery is either fully exhausted or when specific emergency gestures are invoked. Once the emergency battery is in use, non-essential features-including the flashlight, near-field communication (NFC), radio frequency communication (RF), and RFID—are disabled to minimize power draw. Only critical communication protocols, such as push-to-talk and low-energy beacon signals, remain operational to support emergency functions.

Upon activation of the emergency battery module, a real-time battery management interface is presented to the user. This interface logs and displays detailed analytics of total power consumption, categorized by sensors, applications, and user interactions. The log also includes dynamic reallocation data of the emergency battery to critical services as needed. In parallel, the system performs power analysis to generate real-time alerts, recommendations, and intelligent suggestions to guide users on optimized mobile application usage during emergencies-especially when the countdown timer indicates limited time remaining. Furthermore, lightweight near-field communication-based protocols are used to enable last-minute data retrieval, including but not limited to: contact details, payment credentials, QR code usage, medical records, and SOS alerts. Additionally, the proposed system is designed to be interoperable with other compatible mobile devices. Through the use of the custom-developed software application and associated hardware extensions, the system can interrogate and interface with neighboring devices to either initiate emergency communication protocols or transfer critical data securely and efficiently.

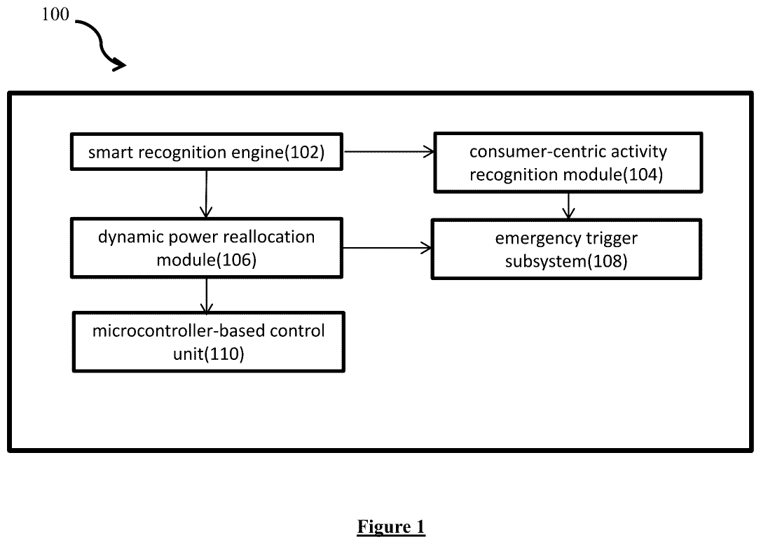

Referring to FIG. 1, a block diagram of a block diagram of a battery management system implemented within a mobile device is illustrated. The system 100 comprises: a smart recognition engine (102) configured to execute on a dedicated processing unit within a system-on-chip (SoC) of the mobile device, the smart recognition engine being trained using time-series telemetry data to generate a dynamic behavioral deviation score based on analysis of at least (i) application invocation frequency, (ii) temporal unlocking patterns, (iii) communication irregularity metrics derived from telephony stack logs, and (iv) motion vector sequences derived from inertial measurement units; a consumer-centric activity recognition module (104), integrated into a sensor abstraction layer of an operating system of the mobile device, the consumer-centric activity recognition module being configured to perform continuous classification of user activity state using a supervised learning classifier trained on fused sensor signals including linear acceleration, rotational velocity, magnetometer orientation, atmospheric pressure, light intensity, and global positioning data, and further configured to output a context risk profile based on deviations from baseline geospatial mobility patterns and circadian usage norms; a dynamic power reallocation module (106) communicatively coupled to a kernel's power governor interface of the mobile device, the dynamic power reallocation module being configured to compute in real time a priority-weighted energy preservation envelope by solving a bounded nonlinear optimization problem, wherein the a priority-weighted energy preservation envelope is based on battery state-of-charge, device thermal profile, projected availability of charging events, and application energy usage gradients computed using moving average discharge rates;

an emergency trigger subsystem (108) configured to assert a system-wide emergency signal to a resource allocation framework of the mobile device, wherein an emergency signal conditionally initiates a restricted operational state in which: (i) an application layer is sandboxed to a whitelist of emergency apps defined by digital signatures and policy rules; (ii) screen luminance and refresh rate are programmatically reduced to minimum human-perceivable thresholds using an embedded display driver configuration registers of the mobile device; (iii) network interfaces are reprogrammed to prioritize emergency call services and GPS location transmission while suspending background data channels; and (iv) all wake-locks and scheduled tasks are selectively disabled except those associated with emergency handler threads running in a protected namespace.

In an embodiment, the smart recognition engine (102) implements a bidirectional long short-term memory (BiLSTM) recurrent neural network configured to ingest historical sequences of application foreground transitions, battery drain rate differentials, and time-aligned user interaction events, and outputs a probabilistic emergency likelihood score exceeding a preset threshold calibrated using cross-validated ROC-AUC analysis during model training; wherein the smart recognition engine, upon receiving classified context input from the consumer-centric activity recognition module, is configured to dynamically adjust its internal temporal prediction window using a recursive window scaling mechanism, wherein length of an input time series is shortened or lengthened based on a volatility index of user activity transitions, computed as a standard deviation of normalized state change frequency over a sliding temporal window, thereby enabling a prediction engine to prioritize fine-grained recent behavior during high-risk contexts while relying on longer-term patterns in stable low-risk periods; andwherein the smart recognition engine utilizes a weighted priority graph to represent inter-application dependencies derived from observed co-activation patterns over time, and wherein during an emergency-triggered battery-constrained state, the smart recognition engine traverses this graph to identify non-leaf nodes representing applications with no critical downstream dependencies and instructs the dynamic power reallocation module to halt all process groups associated with those applications, ensuring that energy preservation does not disrupt essential multi-process workflows such as those involving emergency communication, location sharing, or telephony services.

In an embodiment, the consumer-centric activity recognition module (104), upon detecting spatial deviation from known user mobility patterns using comparative trajectory analysis over prior week's geolocation traces, computes a geospatial anomaly factor, and transmits this factor to the smart recognition engine, which integrates it into a risk model as a multiplicative uncertainty parameter that increases an emergency likelihood score and triggers a preliminary low-power warning state prior to full activation of an emergency mode, thereby allowing staged degradation of non-essential services based on increasing contextual risk; wherein the consumer-centric activity recognition module employs a multi-layer sensor fusion technique incorporating Extended Kalman Filtering (EKF) to synchronize inertial and satellite-based positional data with timestamp resolution below 20 milliseconds, and classifies a user state into a discrete finite-state machine comprising at least six behavioral states: stationary indoor, stationary outdoor, walking, commuting in vehicle, running, and high-risk anomaly, with transition probabilities derived from conditional Markov chains; and wherein the consumer-centric activity recognition module transmits a continuous stream of sensor-derived feature vectors to the smart recognition engine via a low-latency shared memory channel, and wherein feature vectors are preprocessed using a weighted exponential moving average function that gives higher precedence to feature shifts aligned with circadian phase boundaries—such as transitions at sleep onset, morning wake-up, or commuting intervals—thereby enhancing temporal relevance of user activity profiles and enabling early identification of behavior indicative of emerging emergency conditions.

In an embodiment, the emergency mode configures a baseband processor to enter a low-power paging mode while maintaining wake-on-call capability for emergency numbers preloaded into an embedded SIM profile, and wherein GPS module operation is shifted to an ultra-low-power mode utilizing a sub-second location polling interval with assisted ephemeris data from a locally cached satellite prediction file; and wherein the dynamic power reallocation module performs instruction-level instrumentation of kernel-space energy usage using dynamic tracing hooks injected via eBPF (extended Berkeley Packet Filter) scripts, thereby generating a real-time energy attribution map of running kernel threads, and wherein the consumer-centric activity recognition module reassigns processor core affinity to consolidate high-priority emergency tasks to a single efficiency core on a heterogeneous multi-core CPU architecture.

In an embodiment, execution of the emergency mode is governed by a finite-state controller encoded as a lookup transition matrix, where each state corresponds to a level of system degradation tolerance, and transitions between states are driven by a combination of (i) current battery percentage, (ii) computed likelihood of emergency contact activation based on user's prior behavioral history during similar energy profiles, and (iii) real-time system health checks, such that the finite-state controller can autonomously escalate to a critical fallback mode where only the baseband processor, GPS module, and a compressed emergency SMS stack remain operational, with all other peripherals and compute cores placed into deep sleep mode.

In an embodiment, upon triggering of the emergency mode, a background watchdog timer is initialized to periodically perform system integrity checks on an emergency runtime environment, verifying operational health of cellular modem stack, GPS daemon, and secure storage I/O subsystems, and wherein in an event of a critical subsystem failure, the mobile device enters a secondary fallback mode wherein a pre-configured distress SMS containing last-known GPS coordinates is automatically transmitted to a hardcoded recipient number over available GSM fallback channels; and wherein upon activation of the emergency mode, the a secure communication tunnel is initiated between the mobile device and a cloud-hosted emergency management server using a pre-established asymmetric key pair stored within a hardware security module (HSM) of the mobile device, and wherein the mobile device transmits (i) a current GPS location, (ii) residual battery estimate with discharge slope, (iii) top three probable emergency scenario classifications generated by the smart recognition engine, and (iv) last known user interaction log, such that a cloud server can coordinate assistance or notify emergency contacts based on server-side policy orchestration.

In an embodiment, the emergency trigger subsystem (108) includes a hardware interrupt handler embedded within a power management IC (PMIC) firmware, the handler being configured to detect a rising-edge GPIO event corresponding to a user-activated emergency gesture input, such as a rapid triple-press of a power button within a 2-second window, and wherein the handler triggers execution of a low-latency emergency boot sequence with real-time priority threads to initialize essential emergency communication stacks.

In an embodiment, the dynamic power reallocation module (106) interfaces with CPU frequency governor of the mobile device using a kernel-level control thread that dynamically maps process priority levels to specific performance states (P-states) based on an energy utility index, and wherein said energy utility index is computed using a composite formula comprising: (i) a criticality coefficient of each process determined by its emergency role assignment, (ii) a time-since-last-usage value to estimate process dormancy, and (iii) a current battery drain slope over a last 60-second moving average window, such that CPU frequency is forcibly reduced for background threads with low criticality and high dormancy during emergent energy-constrained states; and wherein the dynamic power reallocation module incorporates a transient activity profiler that monitors real-time user interaction latency with foreground applications using kernel instrumentation hooks to capture touch event timestamps and gesture duration intervals, and wherein this profiler calculates a responsiveness coefficient for each active application, such that applications with both low responsiveness and low user interaction density are deprioritized for power allocation by migrating them to low-scheduler priority queues and releasing their wake-locks, thereby conserving energy without compromising real-time user intent.

In an embodiment, the emergency trigger subsystem (108) further comprises a hardware abstraction control layer interfacing directly with a secure boot firmware of the the mobile device, and wherein upon assertion of an emergency trigger, a control layer issues a secure inter-process signal to reconfigure a bootloader's runtime environment to (i) enable a secondary, hardened execution profile that limits system calls to a whitelist defined in a signed policy manifest, (ii) redirect kernel panic handlers to flush device state logs to tamper-evident memory partitions, and (iii) initialize system daemons for services explicitly marked as emergency-critical in a pre-compiled execution map, thereby reducing attack surface and preserving execution integrity under low-battery constraints.

In an embodiment, a reinforcement learning-based adaptive control unit periodically simulates virtual user scenarios by applying synthetic perturbations to stored user activity profiles and measuring corresponding variations in emergency prediction accuracy, and wherein the reinforcement learning-based adaptive control unit uses this feedback to adjust an exploration-exploitation balance in a policy update step, thereby enabling the reinforcement learning-based adaptive control unit to optimize decision thresholds for rare but high-impact emergency patterns that may otherwise be statistically underrepresented in real-world data.

In an embodiment, the smart recognition engine (102) further comprises an internal asynchronous event queue structured as a priority-ranked double-ended queue, wherein high-priority event tokens corresponding to anomalous user behavior signatures are inserted with time-expiry tags, and wherein the smart recognition engine executes a bounded event aggregation function that computes a composite deviation vector by applying time-weighted averaging on event token features within a rolling time window, such that emergent behavioral anomalies are escalated based on temporal proximity and event density prior to classification into a risk score; and wherein the smart recognition engine utilizes a temporal normalization layer implemented as a matrix transformation unit, the unit configured to align multidimensional user interaction vectors-comprising touch density, app-switching cadence, and unlock-screen latencies-onto a common temporal frame of reference using non-linear interpolation and epoch-shifting functions, thereby enabling consistent behavior comparison across asynchronous sensor readings and application events, and ensuring invariant risk modeling under temporal jitter conditions.

In an embodiment, the consumer-centric activity recognition module (104) further includes an environmental variability compensator submodule, the environmental variability compensator submodule being configured to detect fluctuations in sensor precision caused by environmental artifacts such as magnetic field interference or barometric anomalies by comparing real-time sensor signal entropy against stored calibration baselines, and wherein an environmental variability compensator dynamically applies correction factors or selectively ignores unreliable sensor channels in a feature fusion pipeline, thereby ensuring robust context classification under real-world noisy conditions; and wherein the environmental variability compensator submodule is coupled to an adaptive calibration controller configured to execute a sensor self-check routine during idle intervals by inducing micro-movements via haptic motor pulses and correlating expected sensor output patterns with actual responses, and wherein a trust score is generated for each sensor modality, the trust score being used as a multiplicative weight during feature vector construction for behavior classification in the consumer-centric activity recognition module.

In an embodiment, the dynamic power reallocation module (106) performs hierarchical thread energy profiling by injecting kernel-level probes into a scheduler's run queue to measure context-switch frequency, execution duration, and CPU cache miss rates per thread group, and wherein the dynamic power reallocation module constructs a thread-level energy efficiency matrix indexed by process ID and maps the thread-level energy efficiency matrix to priority bands, such that threads with poor energy-to-computation ratios are deprioritized, paused, or reassigned to lower frequency processor clusters, thereby ensuring energy-optimal thread scheduling during emergency states; and wherein the thread-level energy efficiency matrix is updated using an exponentially decayed weighted average of past thread energy usage, and wherein a real-time thermal load monitor is employed to adjust the priority bands by scaling down thread affinity when cumulative die temperature across performance cores exceeds a dynamic thermal ceiling computed as a function of battery discharge slope and ambient temperature sensor readings, thereby preventing thermal runaway in critical low-battery scenarios.

In an embodiment, the secure communication tunnel is established using a session-specific ephemeral key pair derived using Elliptic Curve Diffie-Hellman (ECDH) exchange protocol initialized within a hardware security module, and wherein mutual attestation is performed between the mobile device and a cloud-hosted emergency management server using signed firmware hashes and device-bound certificate chains, and wherein data packets comprising emergency metadata arc AES-GCM encrypted with hardware-accelerated cryptographic operations, ensuring integrity and confidentiality of transmitted emergency data′ and wherein upon transmission failure over primary LTE or 5G channels, a channel fallback routine is executed that scans for available legacy GSM or 2G bands and attempts re-establishment of a communication tunnel using a precompiled band-specific fallback profile stored in secure enclave memory, and wherein a data-throttling encoder compresses an emergency payload using run-length encoding and bit-packing optimizations to ensure successful emergency signal dispatch even under constrained bandwidth.

In an embodiment, the emergency trigger subsystem (108) further comprises a gesture interpretation firmware module integrated within a PMIC microcontroller stack, the gesture interpretation firmware module being configured to capture time-delta sequences between power button interrupts using a high-resolution timer, and applies a dynamic time-tolerance envelope to accommodate user hand tremors or device-specific debounce latencies, and wherein the firmware executes a deterministic finite-state machine (FSM) to validate input gesture sequence before dispatching a trusted interrupt to a system secure monitor, thereby avoiding false positives during accidental button presses; and wherein the FSM includes an adaptive timing window estimator, the adaptive timing window estimator continuously updating its gesture input threshold values based on historical user gesture speed distributions stored in non-volatile memory, such that emergency trigger latency tolerance are dynamically personalized across user profiles to minimize both false triggers and missed activation attempts.

In an embodiment, the reinforcement learning-based adaptive control unit includes a policy optimizer module that simulates low-probability emergency scenarios using synthetic behavior graphs generated from generative adversarial modeling of historic user telemetry, and wherein a policy optimizer evaluates an emergency detection model performance against ground truth labels embedded during synthetic graph generation, and adjusts reward functions used in reinforcement policy training to penalize false negatives in high-risk but rare activity patterns, thereby refining sensitivity without overfitting to dominant user behaviors; and wherein the synthetic behavior graphs are stored in a versioned sandbox dataset and include adversarial perturbation artifacts such as time-warped unlock sequences or randomized GPS jitter patterns, and wherein the policy optimizer includes an anomaly generalization unit that cross-validates model robustness under these adversarial conditions before accepting any policy update for deployment into an inference loop of the smart recognition engine, thereby ensuring resilience of emergency detection under atypical or spoofed usage conditions.

In an embodiment, further comprising a contextual anomaly feedback module communicatively coupled to both the smart recognition engine and the consumer-centric activity recognition module, the contextual anomaly feedback module being configured to: (a) receive a stream of classified activity states and corresponding confidence scores from the consumer-centric activity recognition module; and (b) compute a behavioral entropy index over a sliding time window by measuring variance in classified activity states and divergence from historical activity distributions stored in on-device user profiles; wherein an anomaly feedback module is further configured to transmit a feedback signal to the smart recognition engine when the behavioral entropy index exceeds a context-specific threshold.

In an embodiment, further comprising a secure fallback transmission subsystem, the secure fallback transmission subsystem being configured to: (a) monitor network interface availability across multiple radio access technologies including LTE, 5G, GSM, and Wi-Fi; (b) upon detection of loss or degradation of primary high-bandwidth networks during an active emergency state, initiate a fallback transmission mode by activating a stored band-scanning profile in firmware, the profile including prioritized GSM channel identifiers and baseband modem command sequences; (c) compress a current emergency metadata packet comprising GPS coordinates, battery diagnostics, and top-ranked emergency classification labels using a bitstream-optimized encoding routine based on context-aware data pruning rules; and (d) transmit a compressed emergency payload via a lowest available operational channel, wherein a cyclic redundancy checksum is appended and verified post-transmission using a baseband-level hardware comparator to ensure integrity before acknowledging transmission success.

In an embodiment, further comprising a secure diagnostic and audit logging unit, the unit being implemented as a tamper-resistant microservice within a trusted execution environment (TEE) of the mobile device, and configured to: (a) maintain a chronologically ordered, cryptographically verifiable log of telemetry snapshots, risk evaluations, emergency triggers, power reallocation decisions, and subsystem integrity checks, wherein each log entry is timestamped and hashed using a device-specific hardware root key; (b) upon assertion of an emergency trigger, initiate a secure log flushing procedure to a read-once encrypted partition in NAND flash storage, wherein data retention policies are enforced based on emergency context classification severity and residual battery estimate; and (c) optionally transmit a redacted audit summary to a cloud-hosted emergency policy manager via a pre-negotiated secure tunnel, wherein the redacted audit summary includes hash-linked log digests and anonymized metadata sufficient for remote post-event analysis while preserving user privacy constraints defined in a policy manifest of the battery management system.

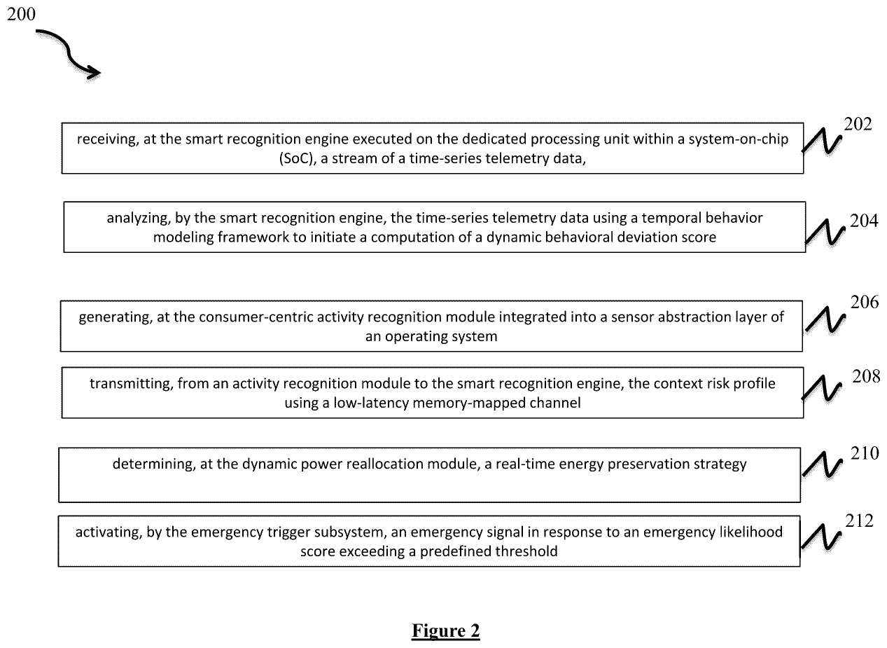

Referring to FIG. 2, a flow chart of a method of operating a battery management battery management system is illustrated. The method 200 comprising: At step 202, the method 200 includes receiving, at the smart recognition engine executed on the dedicated processing unit within a system-on-chip (SoC), a stream of a time-series telemetry data, the stream including at least an application invocation frequency, at least one temporal unlocking pattern, at least one communication irregularity metrics derived from the telephony stack logs, and at least one motion vector sequences obtained from inertial measurement units.

At step 204, the method 200 includes analyzing, by the smart recognition engine, the time-series telemetry data using a temporal behavior modeling framework to initiate a computation of a dynamic behavioral deviation score, wherein the computation includes: (i) performing context normalization based on time-of-day and historical usage phase, (ii) identifying anomalous feature clusters using a recursive deviation scoring function that accounts for temporal variance and magnitude divergence, and (iii) updating a real-time deviation graph to reflect severity and frequency of outlier activity sequences.

At step 206, the method 200 includes generating, at the consumer-centric activity recognition module integrated into a sensor abstraction layer of an operating system, by: (i) continuously acquiring and preprocessing fused sensor signals comprising linear acceleration, rotational velocity, magnetometer orientation, atmospheric pressure, ambient light, and geolocation data; (ii) classifying the user's activity state into one of a finite set of predefined behavioral states using a time-synchronized inference model; and (iii) detecting deviation from personalized circadian and mobility baselines using trajectory dissimilarity metrics and usage phase misalignment.

At step 208, the method 200 includes transmitting, from an activity recognition module to the smart recognition engine, the context risk profile using a low-latency memory-mapped channel, wherein the context risk profile is transmitted and integrated into a behavioral deviation computation as a dynamic weighting factor.

At step 210, the method 200 includes determining, at the dynamic power reallocation module, a real-time energy preservation strategy by: (i) solving a constrained optimization routine that considers battery state-of-charge, device temperature profile, historical charging intervals, and instantaneous application energy usage trends; (ii) dynamically adjusting CPU frequency and voltage levels, screen refresh rate, and background process scheduling based on application energy utility indices; and (iii) generating a control vector that maps application process identifiers to a power state classification matrix, wherein non-essential processes are downscaled or suspended based on low priority and high energy consumption ratios.

At step 212, the method 200 includes activating, by the emergency trigger subsystem, an emergency signal in response to an emergency likelihood score exceeding a predefined threshold, wherein the emergency signal: (i) initiates a restricted operational state that limits system access to digitally signed emergency applications, (ii) configures display registers to enforce power-efficient display parameters, (iii) reprioritizes radio access components to enable emergency telephony and GPS location streaming while disabling auxiliary network services, and (iv) overrides wake-lock permissions such that only those bound to emergency handler threads are retained in an active scheduling pool.

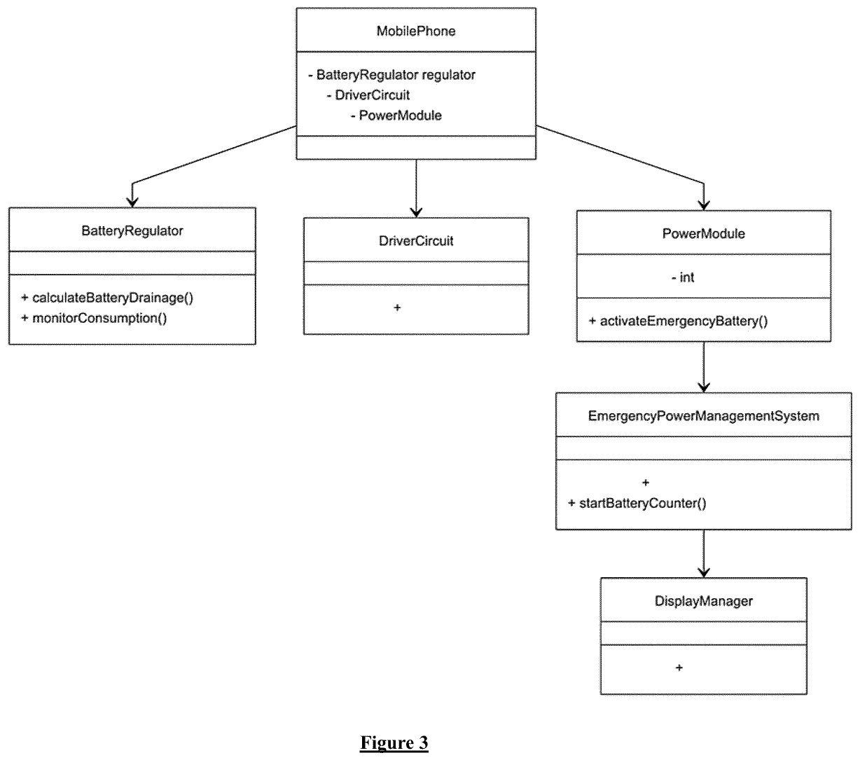

Referring to FIG. 3, at the center of the diagram is the Mobile Phone Motherboard, which acts as the central control hub interfacing all system components. The Emergency Battery block represents a reserved battery unit comprising 10% of the full battery capacity. This emergency battery is connected to a Driver Circuit responsible for regulating when and how the emergency battery is activated. Feeding into this is the R2R Ladder, a resistor-based analog voltage divider circuit used for estimating battery drainage and providing input to the controller for decision-making. From the R2R ladder and Driver Circuit, the control logic connects to the Battery Regulator Circuit, which likely governs switching logic between the main and emergency battery and adjusts voltage levels according to usage scenarios. A logical block labeled as Emergency Battery Management functions as a control decision layer, wherein said block processes signals from the R2R ladder and triggers the emergency supply line when conditions meet the emergency threshold, such as when the main battery is drained. The Sensor Usage Monitoring Block, rightward to the motherboard, is configured to aggregate data from sensors such as accelerometers, gyroscopes, and proximity sensors. This feeds into the AI Software Recognition block, which includes logic for interpreting user behavior and gesture inputs. Adjacent to it is the Gesture Input Unit, responsible for receiving gesture-based triggers like double shake or tap to manually activate emergency mode. This unit feeds into the AI software module to inform the context of activation. A Grayscale Conversion Unit, to the right of the AI module, is configured to send commands to the display controller to switch the UI into a low-power grayscale mode. This mode is activated only under emergency battery operation to conserve power. A Communication Control Block handles enabling or disabling of high-power communication interfaces like NFC, Wi-Fi, or Bluetooth. Only essential communication functions like Push-to-Talk or beacon signals are allowed during emergency mode. An Emergency Application Control Block allows access only to prioritized services such as contacts, QR payment apps, and SOS alert mechanisms. It is managed dynamically by the AI system, which evaluates user intent and usage history. This block diagram effectively outlines the entire operational structure that allows the mobile device to intelligently transition into a constrained emergency mode based on real-time context and power levels.

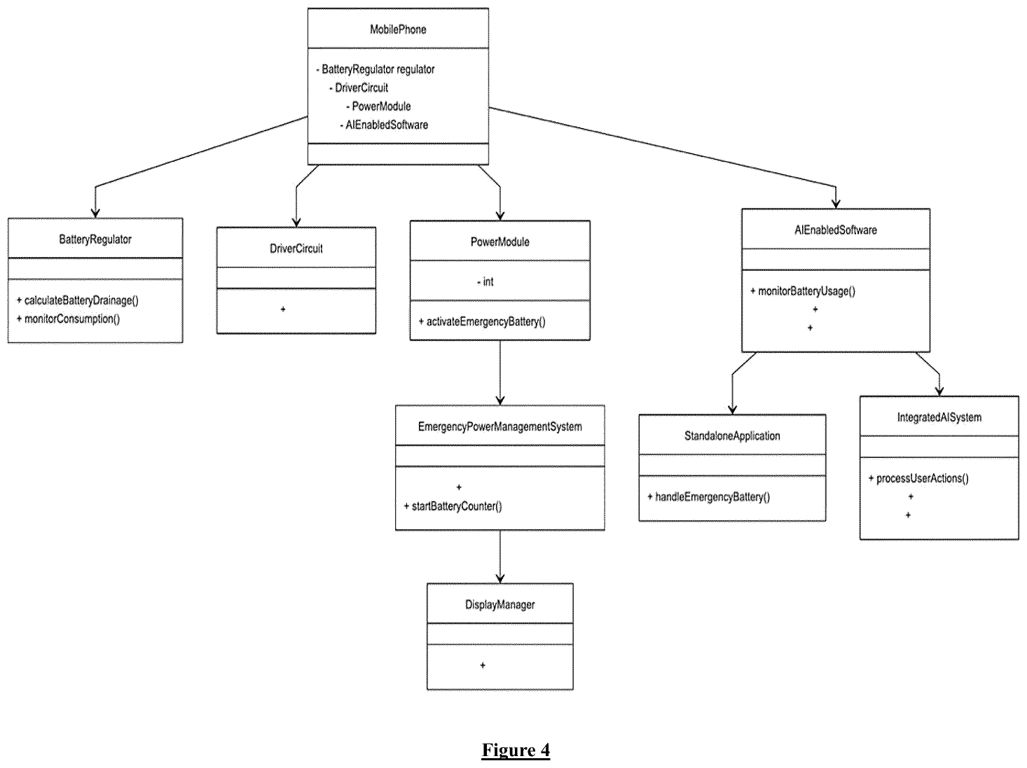

Referring to FIG. 4, the mobile device-based emergency battery management framework incorporates both hardware-level regulation and artificial intelligence (AI)-based decision-making modules. At the center of the architecture lies the Mobile Phone block, which contains references to four core subsystems: the Battery Regulator, Driver Circuit, Power Module, and AI EnabledSoftware. These subsystems collectively manage the activation, operation, and intelligent control of emergency battery power. The Battery Regulator is responsible for calculating real-time power drainage and monitoring battery consumption patterns. It provides the baseline data on which other modules base their decisions. This regulator works in tandem with the DriverCircuit, which acts as an electrical switching and activation interface to channel power between the main and emergency battery units as required. The Power Module contains a function labeled activateEmergencyBattery( ) which is invoked once the system identifies the need to switch to emergency mode. This module directly interfaces with the Emergency Power Management System, which not only initiates the emergency battery usage but also starts the startBatteryCounter, which is a countdown mechanism that informs the user of the remaining available power in emergency mode. The Display Manager, connected downstream of this emergency management system, is the component responsible for rendering a simplified, grayscale user interface to minimize power consumption while still allowing user interaction with essential functions. The intelligence layer, shown in the right side of the diagram, begins with the AI Enabled Software. This software monitors real-time battery usage using the monitorBatteryUsage( ) method and feeds into two possible AI operation modes: Standalone Application and Integrated AI System. The Standalone Application block contains the logic handleEmergencyBattery( ) which represents the case where the AI emergency management runs as a separate mobile app. Conversely, the Integrated AISystem contains processUserActions( ) and related functions to process inputs such as user behavior, gesture recognition, and context-aware event detection to determine whether to trigger the emergency battery switch. These interconnected modules form a comprehensive hybrid system that enables the device to conserve battery intelligently, activate an emergency battery only under critical conditions, and offer user-centric emergency services with power-awareness and real-time feedback.

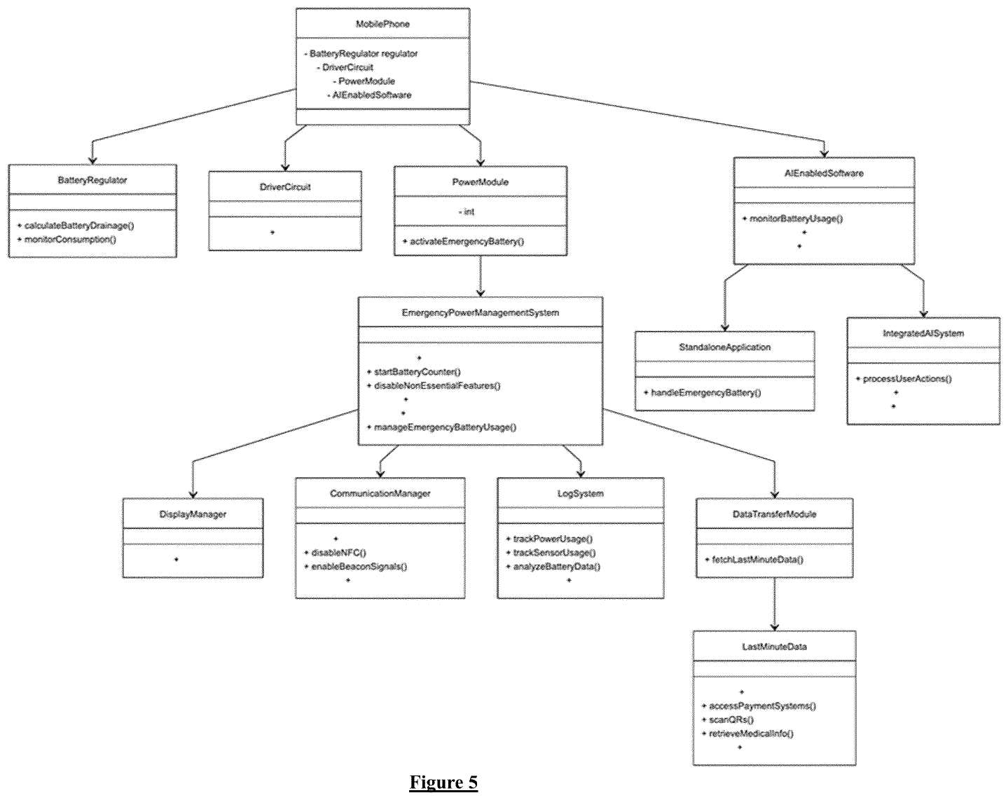

Referring to FIG. 5, at the top of the architecture is the Mobile Phone block, which serves as the parent entity encompassing the core subsystems: Battery Regulator, Driver Circuit, PowerModule, and AI EnabledSoftware. These blocks represent the foundational control, power switching, and decision-making components of the system. The Battery Regulator is responsible for monitoring consumption and executing battery drainage calculations using the calculateBatteryDrainage( ) and monitorConsumption( ) functions. This block continuously feeds battery health and usage data to downstream systems. Beside it, the Driver Circuit acts as the intermediary hardware that facilitates the activation of the emergency supply by responding to electrical and logic signals. The Power Module includes a method activateEmergencyBattery( ) that switches power flow from the main battery to a dedicated emergency battery module. This module connects directly to the central EmergencyPowerManagementSystem, which plays a pivotal role in managing energy resources during critical conditions. This block includes three main functions: startBatteryCounter( ) which begins a countdown timer indicating the estimated remaining time on emergency power; disableNonEssentialFeatures( ) which deactivates high-consumption services like flash, GPS, and background syncing; and manageEmergencyBatteryUsage( ) which applies dynamic policies to prioritize battery usage based on user actions and AI insights. The Emergency Power Management System further connects to four function-specific modules that handle discrete responsibilities:
1. DisplayManager-switches the mobile device's display to a low-power grayscale mode to conserve energy.
2. Communication Manager-manages communication interfaces with the ability to disableNFC( ) and enableBeaconSignals( ) allowing lightweight, emergency-only communication without draining the battery.
3. Log System-performs real-time logging of system activity, including trackPowerUsage( ) trackSensorUsage( ) and analyzeBatteryData( ) This enables both immediate adjustments and long-term learning to improve future performance.
4. Data Transfer Module-offers critical last-minute data access functionality via fetchLastMinuteData( ) This module connects to the LastMinuteData block, where functions such as accessPaymentSystems( ), scanQRs( ), and retrieveMedicalInfo( ), are accessible even under low-battery scenarios. This ensures users can complete time-sensitive or life-critical tasks.

Referring to FIG. 5, on the right half of the architecture lies the intelligence layer, which includes AI Enabled Software, monitoring system-wide battery usage via monitorBatteryUsage( ) and serves as the main input processor for adaptive power decisions. It bifurcates into two operational modes: a Standalone Application, which includes handleEmergencyBattery( ) and represents an app-based version of the emergency control; and an IntegratedAI System, featuring processUserActions( ) and additional context-aware methods to recognize gestures, user priorities, or recent behavior to optimize emergency mode response. This figure demonstrates a tightly integrated system that bridges hardware control and AI-driven logic to ensure that emergency power is intelligently conserved and user needs are met even during critically low battery conditions. The inclusion of dynamic logging, communication throttling, and access to essential services highlights a thoughtful approach to user-centered mobile device resilience.

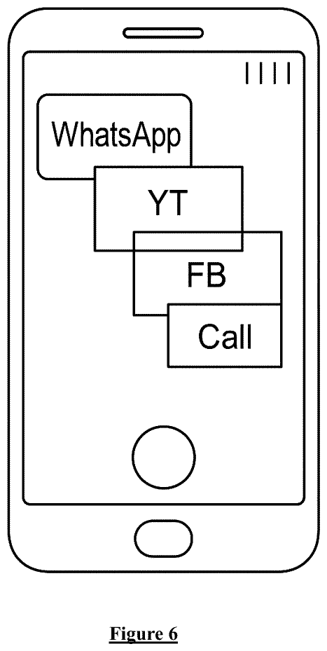

FIG. 6 depicts a conceptual sketch of a mobile phone interface as it appears during emergency battery mode under the control of the proposed smart battery management system. The image shows a simplified representation of a smartphone screen annotated with a few essential application windows stacked upon each other. Labeled apps include WhatsApp, YouTube (YT), Facebook (FB), and Call, visually indicating that these are consumer-prioritized applications whose usage patterns are monitored by the underlying AI system. The visual clustering of apps reflects their relationship to user behavior. This is central to the consumer-centric activity recognition model, which enables the AI module to decide which applications may be allowed limited access during emergency battery conditions. The overlapping layout also metaphorically represents dynamic prioritization, apps more relevant to recent activity or emergency intent (such as calling or WhatsApp) are rendered more accessible, whereas others may be hidden, disabled, or backgrounded to preserve battery. The system is configured for battery management in mobile devices for emergency usage, specifically incorporating Smart Action Recognition and Consumer-Centric Activity Recognition. This aligns with the AI module's function of interpreting gestures (e.g., shake, double-tap) and analyzing app usage logs to automatically initiate emergency mode or optimize application access. The diagram also includes a circular symbol representing the home button or virtual control, likely acting as the access trigger to switch into emergency interface mode. The system implicitly suggests a grayscale screen and a simplified app environment meant for reduced power draw. The FIG. 6, effectively visualizes how emergency operation would look from a user's perspective, and reinforces the invention's focus on user-driven energy prioritization through behavioral modeling and AI adaptation.

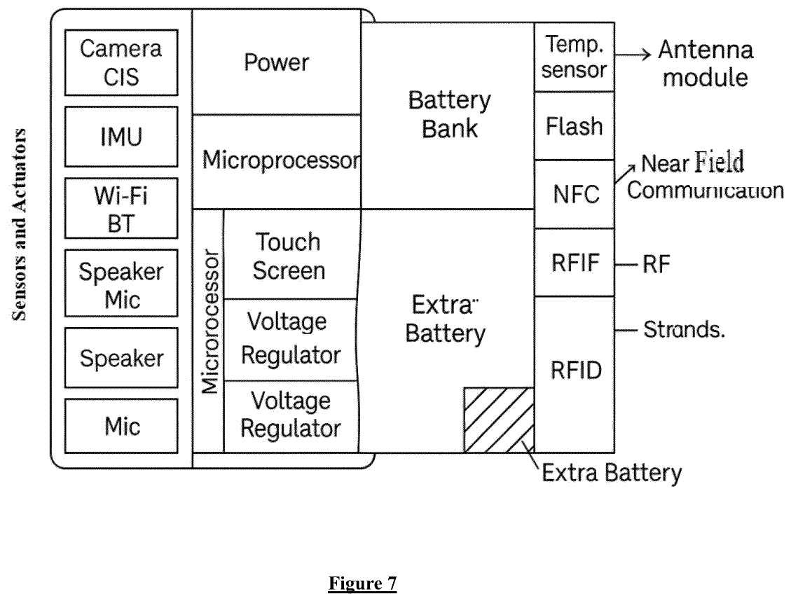

Referring to FIG. 7, various hardware modules located on the mobile device's mainboard are shown, each labeled with its functional domain. In the diagram, the leftmost vertical section is dedicated to sensors and actuators, including a camera and CMOS image sensor, an Inertial Measurement Unit (IMU), Wi-Fi and Bluetooth modules, a speaker, and a microphone. These components represent standard user-interactive elements, and many of them would be disabled or deprioritized when emergency mode is activated to conserve power. Adjacent to the sensor zone is the Display Subsystem, which includes the Display Driver, Touch Screen, and Voltage Regulator. This segment is crucial for rendering the user interface and is power-sensitive. Under emergency mode, the display may shift to grayscale using these hardware lines under control of the emergency software layer. The Microprocessor and Memory module serve as the computational and control brain of the device. The microprocessor interacts with both standard and emergency routines and is responsible for invoking AI modules that analyze usage patterns and decide when to initiate emergency battery procedures. The largest component block is the Battery Bank, which supplies power to the entire system. A distinct, diagonally hatched segment within the battery bank is annotated as the “extra battery”, indicating a physically partitioned emergency battery module reserved for low-capacity but critical power availability. This emergency battery remains isolated under normal operation and is activated via the voltage regulator only during predefined conditions such as complete depletion of the main battery. To the right of the battery, the diagram depicts the Communication and Memory Management Zone, which includes Flash Memory, Near Field Communication (NFC) module, RF circuits, and RFID transceivers. A temperature sensor is placed near this region to monitor thermal activity and possibly govern battery behavior under adverse environmental conditions. The Antenna Module is shown at the top-right corner, interfacing with all wireless communication circuits. Critically, during emergency operation, modules like NFC, RF beacon transmission, and limited RFID-based authentication may remain functional under software control for specific tasks such as sending SOS signals, medical information retrieval, or transferring lightweight data. Other higher-drain components like Bluetooth or camera are shut down or locked unless specifically authorized by emergency AI logic. FIG. 7 captures a modularized physical implementation layout of the invention, emphasizing how a mobile device's internal hardware can be reconfigured to support intelligent emergency battery operations without overhauling its conventional architecture.

The invention disclosed herein relates to a context-aware, adaptive battery management system embedded within a mobile device. The core of the system lies in its ability to intelligently optimize power consumption and enhance device survivability by analyzing contextual user behavior, environmental conditions, and system state using a combination of embedded sensors, a smart recognition engine, and dynamic energy governance logic. The system comprises several interlinked components, notably: a smart recognition engine, an activity classification module, a dynamic power reallocation engine, an emergency mode subsystem, and an emergency tunnel for secure communication, all of which operate in an orchestrated manner through well-defined techniques that execute autonomously in real-time within the device architecture.

The smart recognition engine is a machine learning-based subsystem that continuously ingests telemetry streams from the mobile device's onboard sensors, application state logs, motion patterns, and user-device interaction events. These telemetry data are preprocessed and fed into a behavior vectorization pipeline that applies feature extraction methods-such as statistical summarization, windowed FFT (Fast Fourier Transform) for time-series dynamics, and entropy-based contextualization-across multiple channels. The derived behavioral feature vectors are passed through a trained classifier model, preferably an ensemble model comprising a temporal convolutional neural network (TCN) combined with a decision-level support vector machine (SVM) fusion layer, which outputs a behavioral deviation score. This score quantitatively represents how significantly current user behavior deviates from historical baselines established through prior observation. A deviation score exceeding a calibrated threshold activates either a pre-alert state or directly triggers the emergency mode subsystem, depending on the configuration and the corroborative activity context.

The activity classification module functions in parallel with the smart recognition engine and provides real-time context labeling. This module fuses sensor streams from the accelerometer, gyroscope, magnetometer, ambient light sensor, GPS, and microphone using a multi-modal deep learning model. A hybrid architecture involving a long short-term memory (LSTM) network for time-dependent sequences and a dense convolutional feature extractor is utilized. The model assigns probabilistic activity labels such as “walking,” “running,” “stationary,” “in-vehicle,” “indoors,” “outdoors,” “resting,” and “unknown.” These labels are continuously updated in a short-term activity memory buffer and serve as auxiliary input to the dynamic power reallocation module, as well as the emergency decision logic. For example, a classification of “in-vehicle” during abnormal hours combined with a high deviation score from the recognition engine results in a preemptive reduction of non-critical system power usage and preparation for emergency mode activation.

The dynamic power reallocation engine operates within the kernel-level power manager and orchestrates energy distribution based on the behavioral deviation score, activity classification, and available battery state. The system periodically computes a power priority index (PPI) for all running applications and system services. This PPI is computed based on a utility matrix that considers factors such as: time-sensitive user importance (e.g., messaging or navigation during transit), resource consumption rates, background sync frequency, and prior usage weights. The reallocation engine uses a constrained optimization technique—preferably a real-time variant of convex quadratic programming—to determine which processes to throttle, suspend, or re-prioritize. Additionally, a time-decaying reinforcement feedback loop monitors the energy savings from previous reallocations and uses a regret-minimization technique to adjust future power assignments, improving over time.

When the behavioral deviation score crosses a critical risk threshold, or when the battery state drops below a user-defined or learned survivability threshold, the emergency mode subsystem is automatically engaged. This subsystem enforces a hard switch to a restricted operational mode, where only a whitelist of emergency communication apps, GPS, low-latency notification channels, and trusted services are permitted to run. All other background and foreground processes are suspended, and hardware components such as displays, cameras, and high-throughput radios are downregulated or turned off to conserve power. The emergency mode transition is executed atomically via a system-level interrupt, which invokes a firmware-level override routine residing in the mobile device's embedded controller, ensuring that no user or application can interfere with the transition once triggered.

Simultaneously, the emergency communication tunnel is instantiated using a pre-configured cryptographic handshake with a secure emergency response server. This tunnel is built upon a lightweight UDP-based transmission protocol that is tolerant to high packet loss and low bandwidth, using forward error correction (FEC) and encrypted delta encoding for payloads. The payload contains structured emergency metadata, including timestamped GPS coordinates, current battery level, last known user context, behavioral deviation score, recent activity sequence, and the system decision tree that led to the emergency transition. To ensure end-to-end security, all packets are signed with a digital signature generated from a hardware-anchored private key stored in the device's trusted platform module (TPM). The system also performs optional payload anonymization to preserve user identity during public health or mass-disaster scenarios.

Throughout the lifecycle of device operation, a tamper-resistant logging system continuously maintains a write-once, read-many (WORM) encrypted log that captures every critical decision, power reallocation event, activity recognition result, and emergency transition trigger. This log is maintained within a secure enclave isolated from the general-purpose processing core, ensuring post-event auditability for regulatory, forensic, or performance analysis. The logging engine utilizes a Merkle tree structure to verify log integrity, with periodic root hash commitments stored locally and optionally broadcast to a blockchain node for immutable anchoring.

Additionally, the system supports adaptive personalization via reinforcement learning in a sandboxed training environment. Synthetic user scenarios, including edge-case behaviors and rare emergencies, are generated and used to simulate system response outcomes. These simulations feed into a policy gradient-based update mechanism for the recognition engine, allowing it to refine its deviation thresholds and improve its false-positive and false-negative detection metrics over time.

Altogether, the described invention represents a substantial advancement in mobile battery management technology. By intelligently interpreting context, behavioral patterns, and environmental data using embedded AI models, and dynamically adjusting power policies accordingly, the system ensures that energy is preserved precisely when needed the most. It transcends traditional threshold-based power saving mechanisms and instead enables nuanced, situation-specific, and autonomous energy governance with critical fail-safes and secure response protocols, all functioning locally within the mobile device.

The proposed machine comprises a multilayered embedded battery management device integrated within a system-on-chip (SoC) architecture of a mobile device. At the core of the invention is a smart recognition engine, a machine learning unit implemented on a dedicated processing unit within the SoC. This engine ingests a continuous stream of time-series telemetry data including application invocation frequencies, temporal unlock patterns, communication anomalies derived from telephony stack logs, and motion sequences captured via inertial measurement units. Utilizing a bidirectional long short-term memory (BiLSTM) recurrent neural network, the engine computes a probabilistic emergency likelihood score calibrated against ROC-AUC-validated thresholds. A dynamic temporal scaling mechanism adjusts the window size of input sequences based on volatility indices derived from behavioral transition variances. The smart recognition engine also encodes inter-app dependencies into a weighted graph, allowing for the isolation and suppression of non-critical applications during energy-critical states.

Coupled to this smart engine is the consumer-centric activity recognition module, embedded in the sensor abstraction layer of the operating system. This component is configured to process fused inputs from diverse environmental and positional sensors, including accelerometers, gyroscopes, magnetometers, barometric pressure sensors, ambient light detectors, and GPS receivers. Employing a supervised learning classifier and extended Kalman filtering, the module classifies user activity into discrete states such as stationary, walking, commuting, and high-risk anomalies. Deviations from circadian and mobility baselines are quantified into a context risk profile, which is transmitted via a shared low-latency memory channel to the smart recognition engine for further integration into the behavioral risk computation.

The dynamic power reallocation module forms the decision engine for energy optimization and interacts directly with the kernel's CPU frequency and power governor interfaces. It operates by solving a constrained nonlinear optimization problem based on device battery state, projected charging intervals, real-time thermal maps, and application-wise energy consumption gradients computed via moving average discharge rate vectors. This module uses an energy utility index to evaluate the importance of active processes and reassigns them to appropriate performance states (P-states) or migrates them to efficiency cores in heterogeneous multi-core CPU architectures. The module also leverages extended Berkeley Packet Filter (eBPF) kernel probes to construct a real-time map of thread-level energy attribution, ensuring thread scheduling is adjusted according to thermal constraints and computational efficiency.

When the computed emergency likelihood score crosses a critical threshold, the emergency trigger subsystem asserts a device-wide signal to initiate a restricted operational state. This state includes sandboxing the application layer to a verified whitelist of emergency applications identified by their cryptographic signatures and policy tags. Screen brightness and refresh rate are set to minimum levels using embedded display driver configuration registers. Network interfaces are reprogrammed to retain only emergency telephony and GPS transmission channels, while background processes and wake-locks are suppressed except for those necessary for emergency response daemons operating in a protected runtime namespace.

The device additionally incorporates a hardware interrupt handler embedded within the PMIC (power management integrated circuit) firmware, capable of detecting rapid user gestures such as a triple-press of the power button within a calibrated time window. A dedicated gesture interpretation firmware interprets such interrupts using a finite-state machine with tolerance correction to distinguish intentional emergency gestures from accidental inputs. Upon validation, the system initiates an emergency boot sequence and initializes essential subsystems with real-time thread prioritization.

To enhance emergency response, a secure fallback communication tunnel is established between the mobile device and a cloud-based emergency response platform using a hardware security module (HSM). The tunnel is initialized using elliptic curve Diffie-Hellman (ECDH) key exchange, with encrypted payloads transmitted using AES-GCM under a mutually attested environment. The payload includes current GPS location, top-ranked emergency prediction labels, battery health diagnostics, and anonymized interaction logs. Should the LTE/5G channels fail, the system reverts to a GSM band-scanning fallback mode to ensure delivery of critical emergency messages using compressed and checksum-verified payloads.

An embedded reinforcement learning-based adaptive control unit is configured to simulate synthetic user profiles and perturb historic activity patterns using generative adversarial networks (GANs), optimizing emergency prediction sensitivity to rare but high-impact patterns. This system continuously tunes policy thresholds to maximize true-positive rates in low-frequency emergency scenarios without overfitting on dominant behaviors.

A contextual anomaly feedback module computes a real-time entropy index of behavior state sequences and flags the smart recognition engine when behavior becomes increasingly erratic. Furthermore, the system logs all behavioral deviation scores, emergency transitions, and subsystem operations into a secure diagnostic and audit logging unit implemented within a trusted execution environment (TEE). Logs are hashed using a hardware root key and stored in read-once encrypted NAND flash memory, with optional upload of redacted summaries to remote emergency policy orchestrators for further analysis.

This battery management device presents a unified, context-sensitive, AI-augmented control infrastructure for mobile computing environments, enabling energy-efficient operation, early detection of emergent risk states, and reliable emergency communication even under adverse power and network conditions.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A battery management system implemented within a mobile device, the battery management system comprising:
a smart recognition engine configured to execute on a dedicated processing unit within a system-on-chip (SoC) of the mobile device, the smart recognition engine being trained using time-series telemetry data to generate a dynamic behavioral deviation score based on analysis of at least (i) application invocation frequency, (ii) temporal unlocking patterns, (iii) communication irregularity metrics derived from telephony stack logs, and (iv) motion vector sequences derived from inertial measurement units;
a consumer-centric activity recognition module, integrated into a sensor abstraction layer of an operating system of the mobile device, the consumer-centric activity recognition module being configured to perform continuous classification of user activity state using a supervised learning classifier trained on fused sensor signals including linear acceleration, rotational velocity, magnetometer orientation, atmospheric pressure, light intensity, and global positioning data, and further configured to output a context risk profile based on deviations from baseline geospatial mobility patterns and circadian usage norms;
a dynamic power reallocation module communicatively coupled to a kernel's power governor interface of the mobile device, the dynamic power reallocation module being configured to compute in real time a priority-weighted energy preservation envelope by solving a bounded nonlinear optimization problem, wherein the priority-weighted energy preservation envelope is based on battery state-of-charge, device thermal profile, projected availability of charging events, and application energy usage gradients computed using moving average discharge rates;
an emergency trigger subsystem configured to assert a system-wide emergency signal to a resource allocation framework of the mobile device, wherein an emergency signal conditionally initiates a restricted operational state in which:
(i) an application layer is sandboxed to a whitelist of emergency apps defined by digital signatures and policy rules;
(ii) screen luminance and refresh rate are programmatically reduced to minimum human-perceivable thresholds using an embedded display driver configuration registers of the mobile device;
(iii) network interfaces are reprogrammed to prioritize emergency call services and GPS location transmission while suspending background data channels; and
(iv) all wake-locks and scheduled tasks are selectively disabled except those associated with emergency handler threads running in a protected namespace; and
wherein the smart recognition engine implements a bidirectional long short-term memory (BiLSTM) recurrent neural network configured to ingest historical sequences of application foreground transitions, battery drain rate differentials, and time-aligned user interaction events, and outputs a probabilistic emergency likelihood score exceeding a preset threshold calibrated;
wherein the smart recognition engine, upon receiving classified context input from the consumer-centric activity recognition module, is configured to dynamically adjust its internal temporal prediction window using a recursive window scaling mechanism, wherein length of an input time series is shortened or lengthened based on a volatility index of user activity transitions, computed as a standard deviation of normalized state change frequency over a sliding temporal window, thereby enabling a prediction engine to prioritize fine-grained recent behavior during high-risk contexts while relying on longer-term patterns in stable low-risk periods; and
wherein the smart recognition engine utilizes a weighted priority graph to represent inter-application dependencies derived from observed co-activation patterns over time, and wherein during an emergency-triggered battery-constrained state, the smart recognition engine traverses this graph to identify non-leaf nodes representing applications with no critical downstream dependencies and instructs the dynamic power reallocation module to halt all process groups associated with those applications, ensuring that energy preservation does not disrupt essential multi-process workflows such as those involving emergency communication, location sharing, or telephony services.

2. The battery management system of claim 1, wherein the consumer-centric activity recognition module, upon detecting spatial deviation from known user mobility patterns using comparative trajectory analysis over prior week's geolocation traces, computes a geospatial anomaly factor, and transmits this factor to the smart recognition engine, which integrates it into a risk model as a multiplicative uncertainty parameter that increases an emergency likelihood score and triggers a preliminary low-power warning state prior to full activation of an emergency mode, thereby allowing staged degradation of non-essential services based on increasing contextual risk;
wherein the consumer-centric activity recognition module employs a multi-layer sensor fusion technique incorporating Extended Kalman Filtering (EKF) to synchronize inertial and satellite-based positional data with timestamp resolution below 20 milliseconds, and classifies a user state into a discrete finite-state machine comprising at least six behavioral states: stationary indoor, stationary outdoor, walking, commuting in vehicle, running, and high-risk anomaly, with transition probabilities derived from conditional Markov chains; and
wherein the consumer-centric activity recognition module transmits a continuous stream of sensor-derived feature vectors to the smart recognition engine via a low-latency shared memory channel, and wherein feature vectors are preprocessed using a weighted exponential moving average function that gives higher precedence to feature shifts aligned with circadian phase boundaries-such as transitions at sleep onset, morning wake-up, or commuting intervals-thereby enhancing temporal relevance of user activity profiles and enabling early identification of behavior indicative of emerging emergency conditions.

3. The battery management system of claim 2, wherein the emergency mode configures a baseband processor to enter a low-power paging mode while maintaining wake-on-call capability for emergency numbers preloaded into an embedded SIM profile, and wherein GPS module operation is shifted to an ultra-low-power mode utilizing a sub-second location polling interval with assisted ephemeris data from a locally cached satellite prediction file; and wherein the dynamic power reallocation module performs instruction-level instrumentation of kernel-space energy usage using dynamic tracing hooks injected via eBPF (extended Berkeley Packet Filter) scripts, thereby generating a real-time energy attribution map of running kernel threads, and wherein the consumer-centric activity recognition module reassigns processor core affinity to consolidate high-priority emergency tasks to a single efficiency core on a heterogeneous multi-core CPU architecture.

4. The battery management system of claim 3, wherein execution of the emergency mode is governed by a finite-state controller encoded as a lookup transition matrix, where a state corresponds to a level of system degradation tolerance, and transitions between states are driven by a combination of (i) current battery percentage, (ii) computed likelihood of emergency contact activation based on user's prior behavioral history during similar energy profiles, and (iii) real-time system health checks, such that the finite-state controller can autonomously escalate to a critical fallback mode where only the baseband processor, GPS module, and a compressed emergency SMS stack remain operational, with all other peripherals and compute cores placed into deep sleep mode.

5. The battery management system of claim 2, wherein upon triggering of the emergency mode, a background watchdog timer is initialized to periodically perform system integrity checks on an emergency runtime environment, verifying operational health of cellular modem stack, GPS daemon, and secure storage I/O subsystems, and wherein in an event of a critical subsystem failure, the mobile device enters a secondary fallback mode wherein a pre-configured distress SMS containing last-known GPS coordinates is automatically transmitted to a hardcoded recipient number over available GSM fallback channels; and wherein upon activation of the emergency mode, the a secure communication tunnel is initiated between the mobile device and a cloud-hosted emergency management server using a pre-established asymmetric key pair stored within a hardware security module (HSM) of the mobile device, and wherein the mobile device transmits (i) a current GPS location, (ii) residual battery estimate with discharge slope, (iii) top three probable emergency scenario classifications generated by the smart recognition engine, and (iv) last known user interaction log, such that a cloud server can coordinate assistance or notify emergency contacts based on server-side policy orchestration.

6. The battery management system of claim 1, wherein the emergency trigger subsystem includes a hardware interrupt handler embedded within a power management IC (PMIC) firmware, the handler being configured to detect a rising-edge GPIO event corresponding to a user-activated emergency gesture input, such as a rapid triple-press of a power button within a 2-second window, and wherein the handler triggers execution of a low-latency emergency boot sequence with real-time priority threads to initialize essential emergency communication stacks.

7. The battery management system of claim 1, wherein the dynamic power reallocation module interfaces with CPU frequency governor of the mobile device using a kernel-level control thread that dynamically maps process priority levels to specific performance states (P-states) based on an energy utility index, and wherein said energy utility index is computed using a composite formula comprising: (i) a criticality coefficient of each process determined by its emergency role assignment, (ii) a time-since-last-usage value to estimate process dormancy, and (iii) a current battery drain slope over a last 60-second moving average window, such that CPU frequency is forcibly reduced for background threads with low criticality and high dormancy during emergent energy-constrained states; and
wherein the dynamic power reallocation module incorporates a transient activity profiler that monitors real-time user interaction latency with foreground applications using kernel instrumentation hooks to capture touch event timestamps and gesture duration intervals, and wherein this profiler calculates a responsiveness coefficient for each active application, such that applications with both low responsiveness and low user interaction density are deprioritized for power allocation by migrating them to low-scheduler priority queues and releasing their wake-locks, thereby conserving energy without compromising real-time user intent.

8. The battery management system of claim 1, wherein the emergency trigger subsystem further comprises a hardware abstraction control layer interfacing directly with a secure boot firmware of the mobile device, and wherein upon assertion of an emergency trigger, a control layer issues a secure inter-process signal to reconfigure a bootloader's runtime environment to (i) enable a secondary, hardened execution profile that limits system calls to whitelist defined in a signed policy manifest, (ii) redirect kernel panic handlers to flush device state logs to tamper-evident memory partitions, and (iii) initialize system daemons for services explicitly marked as emergency-critical in a pre-compiled execution map, thereby reducing attack surface and preserving execution integrity under low-battery constraints.

9. The battery management system of claim 1, wherein a reinforcement learning-based adaptive control unit periodically simulates virtual user scenarios by applying synthetic perturbations to stored user activity profiles and measuring corresponding variations in emergency prediction accuracy, and wherein the reinforcement learning-based adaptive control unit uses this feedback to adjust an exploration-exploitation balance in a policy update step, thereby enabling the reinforcement learning-based adaptive control unit to optimize decision thresholds for rare but high-impact emergency patterns that may otherwise be statistically underrepresented in real-world data.

10. The battery management system of claim 1, wherein the smart recognition engine further comprises an internal asynchronous event queue structured as a priority-ranked double-ended queue, wherein high-priority event tokens corresponding to anomalous user behavior signatures are inserted with time-expiry tags, and wherein the smart recognition engine executes a bounded event aggregation function that computes a composite deviation vector by applying time-weighted averaging on event token features within a rolling time window, such that emergent behavioral anomalies are escalated based on temporal proximity and event density prior to classification into a risk score; and wherein the smart recognition engine utilizes a temporal normalization layer implemented as a matrix transformation unit, the unit configured to align multidimensional user interaction vectors comprising touch density, app-switching cadence, and unlock-screen latencies-onto a common temporal frame of reference using non-linear interpolation and epoch-shifting functions, thereby enabling consistent behavior comparison across asynchronous sensor readings and application events, and ensuring invariant risk modeling under temporal jitter conditions.

11. The battery management system of claim 2, wherein the consumer-centric activity recognition module further includes an environmental variability compensator submodule, the environmental variability compensator submodule being configured to detect fluctuations in sensor precision caused by environmental artifacts such as magnetic field interference or barometric anomalies by comparing real-time sensor signal entropy against stored calibration baselines, and wherein an environmental variability compensator dynamically applies correction factors or selectively ignores unreliable sensor channels in a feature fusion pipeline; and wherein the environmental variability compensator submodule is coupled to an adaptive calibration controller configured to execute a sensor self-check routine during idle intervals by inducing micro-movements via haptic motor pulses and correlating expected sensor output patterns with actual responses, and wherein a trust score is generated for each sensor modality, the trust score being used as a multiplicative weight during feature vector construction for behavior classification in the consumer-centric activity recognition module.

12. The battery management system of claim 3, wherein the dynamic power reallocation module performs hierarchical thread energy profiling by injecting kernel-level probes into a scheduler's run queue to measure context-switch frequency, execution duration, and CPU cache miss rates per thread group, and wherein the dynamic power reallocation module constructs a thread-level energy efficiency matrix indexed by process ID and maps the thread-level energy efficiency matrix to priority bands, such that threads with poor energy-to-computation ratios are deprioritized, paused, or reassigned to lower frequency processor clusters, thereby ensuring energy-optimal thread scheduling during emergency states; and wherein the thread-level energy efficiency matrix is updated using an exponentially decayed weighted average of past thread energy usage, and wherein a real-time thermal load monitor is employed to adjust the priority bands by scaling down thread affinity when cumulative die temperature across performance cores exceeds a dynamic thermal ceiling computed as a function of battery discharge slope and ambient temperature sensor readings, thereby preventing thermal runaway in critical low-battery scenarios.

13. The battery management system of claim 5, wherein the secure communication tunnel is established using a session-specific ephemeral key pair derived using Elliptic Curve Diffic-Hellman (ECDH) exchange protocol initialized within a hardware security module, and wherein mutual attestation is performed between the mobile device and a cloud-hosted emergency management server using signed firmware hashes and device-bound certificate chains, and wherein data packets comprising emergency metadata are AES-GCM encrypted with hardware-accelerated cryptographic operations, ensuring integrity and confidentiality of transmitted emergency data′ and wherein upon transmission failure over primary LTE or 5G channels, a channel fallback routine is executed that scans for available GSM or 2G bands and attempts re-establishment of a communication tunnel using a precompiled band-specific fallback profile stored in secure enclave memory, and wherein a data-throttling encoder compresses an emergency payload using run-length encoding and bit-packing optimizations to ensure successful emergency signal dispatch even under constrained bandwidth.

14. The battery management system of claim 6, wherein the emergency trigger subsystem further comprises a gesture interpretation firmware module integrated within a PMIC microcontroller stack, the gesture interpretation firmware module being configured to capture time-delta sequences between power button interrupts using a high-resolution timer, and applies a dynamic time-tolerance envelope to accommodate user hand tremors or device-specific debounce latencies, and wherein the firmware executes a deterministic finite-state machine (FSM) to validate input gesture sequence before dispatching a trusted interrupt to a system secure monitor, thereby avoiding false positives during accidental button presses; and wherein the FSM includes an adaptive timing window estimator, the adaptive timing window estimator continuously updating its gesture input threshold values based on historical user gesture speed distributions stored in non-volatile memory, such that emergency trigger latency tolerance are dynamically personalized across user profiles to minimize both false triggers and missed activation attempts.

15. The battery management system of claim 9, wherein the reinforcement learning-based adaptive control unit includes a policy optimizer module that simulates low-probability emergency scenarios using synthetic behavior graphs generated from generative adversarial modeling of historic user telemetry, and wherein a policy optimizer evaluates an emergency detection model performance against ground truth labels embedded during synthetic graph generation, and adjusts reward functions used in reinforcement policy training to penalize false negatives in high-risk but rare activity patterns, thereby refining sensitivity without overfitting to dominant user behaviors; and wherein the synthetic behavior graphs are stored in a versioned sandbox dataset and include adversarial perturbation artifacts such as time-warped unlock sequences or randomized GPS jitter patterns, and wherein the policy optimizer includes an anomaly generalization unit that cross-validates model robustness under these adversarial conditions before accepting a policy update for deployment into an inference loop of the smart recognition engine, thereby ensuring resilience of emergency detection under atypical or spoofed usage conditions.

16. The battery management system of claim 1, further comprising a contextual anomaly feedback module communicatively coupled to both the smart recognition engine and the consumer-centric activity recognition module, the contextual anomaly feedback module being configured to:
(a) receive a stream of a plurality of classified activity states and corresponding confidence scores from the consumer-centric activity recognition module; and
(b) compute a behavioral entropy index over a sliding time window by measuring variance in the classified activity states and divergence from historical activity distributions stored in on-device user profiles; wherein an anomaly feedback module is further configured to transmit a feedback signal to the smart recognition engine when the behavioral entropy index exceeds a context-specific threshold.

17. The battery management system of claim 1, further comprising a secure fallback transmission subsystem, the secure fallback transmission subsystem being configured to:
(a) monitor network interface availability across multiple radio access technologies including LTE, 5G, GSM, and Wi-Fi;
(b) upon detection of loss or degradation of primary high-bandwidth networks during an active emergency state, initiate a fallback transmission mode by activating a stored band-scanning profile in firmware, the profile including prioritized GSM channel identifiers and baseband modem command sequences;
(c) compress a current emergency metadata packet comprising GPS coordinates, battery diagnostics, and top-ranked emergency classification labels using a bitstream-optimized encoding routine based on context-aware data pruning rules; and
(d) transmit a compressed emergency payload via a lowest available operational channel, wherein a cyclic redundancy checksum is appended and verified post-transmission using a baseband-level hardware comparator to ensure integrity before acknowledging transmission success.

18. The battery management system of claim 1, further comprising a secure diagnostic and audit logging unit, the unit being implemented as a tamper-resistant microservice within a trusted execution environment (TEE) of the mobile device, and configured to:
(a) maintain a chronologically ordered, cryptographically verifiable log of telemetry snapshots, risk evaluations, emergency triggers, power reallocation decisions, and subsystem integrity checks, wherein each log entry is timestamped and hashed using a device-specific hardware root key;
(b) upon assertion of an emergency trigger, initiate a secure log flushing procedure to a read-once encrypted partition in NAND flash storage, wherein data retention policies are enforced based on emergency context classification severity and residual battery estimate; and
(c) optionally transmit a redacted audit summary to a cloud-hosted emergency policy manager via a pre-negotiated secure tunnel, wherein the redacted audit summary includes hash-linked log digests and anonymized metadata sufficient for remote post-event analysis while preserving user privacy constraints defined in a policy manifest of the battery management system.

19. A method of operating a battery management battery management system of claim 1, the method comprising:
receiving, at the smart recognition engine executed on the dedicated processing unit within a system-on-chip (SoC), a stream of a time-series telemetry data, the stream including at least an application invocation frequency, at least one temporal unlocking pattern, at least one communication irregularity metrics derived from the telephony stack logs, and at least one motion vector sequences obtained from inertial measurement units;
analyzing, by the smart recognition engine, the time-series telemetry data using a temporal behavior modeling framework to initiate a computation of a dynamic behavioral deviation score, wherein the computation includes:
(i) performing context normalization based on time-of-day and historical usage phase,
(ii) identifying anomalous feature clusters using a recursive deviation scoring function that accounts for temporal variance and magnitude divergence, and
(iii) updating a real-time deviation graph to reflect severity and frequency of outlier activity sequences;
generating, at the consumer-centric activity recognition module integrated into a sensor abstraction layer of an operating system, by:
(i) continuously acquiring and preprocessing fused sensor signals comprising a linear acceleration, a rotational velocity, a magnetometer orientation, an atmospheric pressure, an ambient light, and a geolocation data;
(ii) classifying the user's activity state into one of a finite set of predefined behavioral states using a time-synchronized inference model; and
(iii) detecting deviation from personalized circadian and mobility baselines using trajectory dissimilarity metrics and usage phase misalignment;
transmitting, from an activity recognition module to the smart recognition engine, the context risk profile using a low-latency memory-mapped channel, wherein the context risk profile is transmitted and integrated into a behavioral deviation computation as a dynamic weighting factor;
determining, at the dynamic power reallocation module, a real-time energy preservation strategy by:
(i) solving a constrained optimization routine that considers battery state-of-charge, device temperature profile, historical charging intervals, and
instantaneous application energy usage trends;
(ii) dynamically adjusting CPU frequency and voltage levels, screen refresh rate, and background process scheduling based on application energy utility indices; and
(iii) generating a control vector that maps application process identifiers to a power state classification matrix, wherein non-essential processes are downscaled or suspended based on low priority and high energy consumption ratios;
activating, by the emergency trigger subsystem, an emergency signal in response to an emergency likelihood score exceeding a predefined threshold, wherein the emergency signal:
(i) initiates a restricted operational state that limits system access to digitally signed emergency applications,
(ii) configures display registers to enforce power-efficient display parameters,
(iii) reprioritizes radio access components to enable emergency telephony and GPS location streaming while disabling auxiliary network services, and
(iv) overrides wake-lock permissions such that only those bound to emergency handler threads are retained in an active scheduling pool.
